(19) United States
(12) Patent Application Publication
(10) Pub. No.: US 2024/0418152 A1
(43) Pub. Date: Dec. 19, 2024

(54) WIND TURBINE BLADE INSTALLATION SYSTEM AND RELATED METHODS

(71) Applicant: Gregory John NEIGHBOURS, Auckland (NZ)

(72) Inventor: Gregory John NEIGHBOURS, Auckland (NZ)

(21) Appl. No.: 18/712,675

(22) PCT Filed: Nov. 23, 2022
(86) PCT No.: PCT/IB2022/061311

§ 371 Date: May 22, 2024

(30) Foreign Application Priority Data
Nov. 23, 2021 (AU) 2021903775

(51) Int. Cl. F03D 13/10; B66C 1/10; B66C 23/18

(52) U.S. Cl. CPC F03D 13/108; B66C 1/108; B66C 23/185; F05B 2230/61; F05B 2260/301

(57) ABSTRACT

A method and related system for installing a wind turbine blade to a rotor head of a nacelle located on top of a tower of a wind power generator, the method comprising hoisting the blade up the tower to a substantially vertical orientation, where movement thereof up the tower is guided by at least one carriage intermediate the blade and the tower and removably secured to the blade, the at least one carriage contacting with an outer surface or surfaces of the tower as the blade is being hoisted.

The present invention relates to a wind turbine blade installation system and related methods of wind turbine blade installation.

### BACKGROUND

Wind turbine blade installation typically involves the lifting up of wind turbine blades to a rotor hub or head of a nacelle on top of a tower of a wind turbine. Given the height of most wind turbines (around or above 100 meters) this can be dangerous and thus time-consuming and costly process.

Known methods may utilise a plurality of high-reaching cranes supported at ground level and connecting to various parts of the blade to iteratively lift the blade further and further up until it reaches the nacelle of the wind turbine. This can be a peculiar process in the typically high-wind conditions of wind turbine installation farms/field, where strong winds can cause dangerous swaying of the crane cables and thus blade itself. Further, swaying can sometimes reach resonance, resulting in very high frequency and amplitude movement of the crane cables/blade. This is both dangerous and can often make final alignment of the blade with the rotor hub or head of a nacelle very difficult. Cranes mounted to the towers themselves may also require complex and time-consuming assembly and disassembly processes, further increasing cost and construction time.

Other methods may utilise air-vehicles, such as helicopters, to airlift the blades directly up to the nacelle. This can however be very expensive given the required tonnage of the helicopter(s) required to lift the blades and resulting fuel consumption. Further, high-wind conditions can often deem flight un-safe, thereby stalling if not completely preventing airlifting as an option.

Therefore, there is a need to provide a wind turbine blade installation system, and corresponding method, that at least partly circumnavigates the above-mentioned problems of known methods and systems.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

For the purpose of this specification, where method steps are described in sequence, the sequence does not necessarily mean that the steps are to be chronologically ordered in that sequence, unless there is no other logical manner of interpreting the sequence.

It is an object of the present invention to provide a wind turbine blade installation system and/or method which overcomes or at least partially ameliorates some of the abovementioned disadvantages or which at least provides the public with a useful choice.

### BRIEF DESCRIPTION OF THE INVENTION

In a first aspect the present invention may be said to be a method for installing a wind turbine blade to a rotor head of a nacelle located on top of a tower of a wind power generator, the method comprising:
hoisting the blade up the tower in an orientation presenting the blade root uppermost and the blade extending substantially vertically, guided by the tower by at least one carriage intermediate the blade and the tower and that is removably secured to the blade and that is in contact with an outer surface or surfaces of the tower as the blade is hoisted,
if required, optionally positioning the blade root to be in alignment with a blade mounting flange of the rotor head so that root bolts are able to insert into root bolt apertures, by adjusting the position of the blade relative to the tower using the at least one carriage,
moving the blade to insert root bolts into the bolt apertures, and
securing the blade to the rotor head using the root bolts.

Preferably the at least one carriage is an upper carriage secured to the blade during hoisting at or proximate the blade root.

Preferably said hoisting is by a support cable or rope releasably attached to the blade and/or the at least one carriage (preferably the upper carriage).

Preferably the method further comprises, prior to said hoisting, attaching a support cable or rope to (preferably an anchor such as a hoist anchor of) the blade and/or at least one carriage.

Preferably the method comprises, prior to said hoisting, attaching a support cable or rope to the blade and/or at least one carriage when the blade, with said at least one carriage secured to it, is in a substantially horizontal condition supported by ground adjacent the tower.

Preferably the blade, prior to said hoisting, is supported by the ground on a support vehicle or support rack.

Preferably the blade is transitioned from its horizontal condition to its vertical tower guided hoisting condition by a crane.

Preferably the blade is transitioned from its horizontal condition to its vertical tower guided hoisting condition by a crane that can lift the blade.

Preferably the blade is transitioned from its horizontal condition to its vertical tower guided hoisting condition by a crane that can lift the blade at a location spaced from the hoist anchor.

Preferably the location spaced apart, is defined by a lifting anchor of the blade.

Preferably the lifting anchor is located more proximate the blade tip than then where the hoisting of the blade occurs.

Preferably the at least one carriage is an upper carriage secured to the blade during hoisting at or proximate the blade root and wherein the location spaced apart is defined by a second of said at least one carriage, secured to the blade more proximate the blade tip.

Preferably the crane comprises a lifting boom and a lifting cable or rope that extends from the lifting boom to the blade to lift the blade.

Preferably the crane is vehicle mounted.

Preferably, in the horizontal condition, the blade and the at least one carriage are separated from the tower.

Preferably the crane and the support cable in concert suspend and move the blade from its horizontal condition to its hoisting condition.

Preferably the crane and the support cable in concert suspend and move the blade from its horizontal condition to its hoisting condition by bringing the at least one carriage in contact with an outer surface or surfaces of the tower.

Preferably the crane is disconnected from the blade once the blade is vertical and the at least one carriage is located against the tower.

Preferably the crane is disconnected from the blade once the blade is fully suspended only by the hoisting cable or rope.

Preferably in the hoisting condition, at least two and preferably 3 carriages are releasably secured to the blade at spaced apart locations, are guided by the tower located intermediate the blade and the tower.

Preferably in the hoisting condition, and upper carriage is releasably secured to the blade at or proximate the blade root, a lower carriage is releasable secured to the blade proximate the blade tip and independent from the upper carriage.

Preferably the at least one carriage comprises of wheels or bearings able to move on and over the surface of surfaces of the tower during said hoisting.

Preferably the wheels or bearings help prevent the blade, during hoisting from swinging relative to the tower.

Preferably the at least one carriage comprises of wheels or bearings able to move over the surface of surfaces of the tower and hold said blade at where the at least one carriage is secured to the blade at a predetermined distance from the tower.

Preferably the at least one carriage comprises of wheels or bearings able to move over the surface of surfaces of the tower and hold said blade at where the at least one carriage is secured to the blade at a predetermined radial position from the tower.

Preferably the at least one carriage comprises of wheels or bearings able to move over the surface of surfaces of the tower and hold said blade at where the at least one carriage is secured to the blade at a predetermined tangential position from the tower.

Preferably the positioning of the blade is achieved by said at least one carriage.

Preferably said at least one carriage (preferably at least said upper carriage) comprises a mechanism that allows the relative position of the blade and the tower to be adjusted.

Preferably said mechanism is an at least two axis translation mechanism.

Preferably said mechanism is an at least two axis translation mechanism able to displace the blade radially and tangentially relative to the tower at said carriage.

Preferably the mechanism is able to cause the moving of the blade to insert the root bolts into the bolt apertures.

Preferably the at least one carriage is in sliding or rolling contact with the tower during hoisting of the blade.

Preferably the hoisting occurs from a hoist point above the blade.

Preferably the hoist point is fixed relative to the tower.

Preferably the hoist point is located such that there is a gravitational bias on the blade and its secured carriage(s) during hoisting towards the tower surface of surfaces.

Preferably a winch to hoist the blade is supported by the ground on which the tower is supported.

Preferably a winch to hoist the blade is secured by the ground on which the tower is supported.

Preferably a winch to hoist the blade is secured to and on the ground on which the tower is supported.

Preferably the support cable or rope during hoisting extends from the blade or said at least one carriage upwardly to a hoist point.

Preferably the support cable or rope during hoisting extends from the blade or said at least one carriage upwardly to a hoist point and from the hoist point toward the ground to a hoist winch.

Preferably after securing the blade the at least one carriage is removed from the blade.

Preferably after securing the blade the at least one carriage is removed from the blade and lowered to the ground.

Preferably after securing the blade the at least one carriage is removed from the blade and lowered to the ground by the support cable.

Preferably the blade is delivered from a remote location to the wind power generator by a support vehicle preferably being a road vehicle (e.g. by a truck, e.g. on the trailer of the truck).

Preferably the blade is delivered from a remote location to the wind power generator by a support vehicle and the crane is mounted to said vehicle.

In a further aspect the present invention may be said to be a method for removing a wind turbine blade from a rotor head of a nacelle located on top of a tower of a wind power generator, the method comprising:
un-securing root bolts of the blade with rotor head,
moving the blade to remove the root bolts from the bolt apertures, and
lowering the blade down the tower in an orientation presenting the blade root uppermost and the blade extending substantially vertically, guided by the tower by at least one carriage intermediate the blade and the tower and that is removably secured to the blade and that is in contact with an outer surface or surfaces of the tower as the blade is lowered.

Preferably the at least one carriage is secured to the blade before said lowering.

Preferably the at least one carriage is an upper carriage secured to the blade during lowering at or proximate the blade root.

Preferably wherein said lowering is by a support cable or rope releasably attached to the blade and/or the at least one carriage (preferably the upper carriage).

Preferably the method further comprises, prior to said lowering (and preferably prior to said un-securing), attaching a support cable or rope to (preferably a hoist anchor of) the blade and/or at least one carriage.

Preferably the blade is lowered onto a support vehicle or support rack.

Preferably the blade is transitioned from vertical tower guided hoisting condition to its horizontal condition to by a crane.

Preferably the blade is transitioned from vertical tower guided hoisting condition to its horizontal condition to by a crane that can lift the blade.

Preferably the blade is transitioned from vertical tower guided hoisting condition to its horizontal condition to by a crane that can lift the blade at a location spaced from the hoist anchor.

Preferably the location spaced apart, is defined by a lifting anchor of the blade.

Preferably the lifting anchor is located more proximate the blade tip than then where the lowering of the blade occurs.

Preferably, in the horizontal condition, the blade and the at least one carriage are separated from the tower.

Preferably the crane and the support cable in concert suspend and move the blade from its vertical lowering condition to its horizontal condition.

Preferably the lowering occurs from a hoist point above the blade.

Preferably a winch to lower the blade is supported by the ground on which the tower is supported.

Preferably a winch is secured by the ground on which the tower is supported.

Preferably a winch is secured to and on the ground on which the tower is supported.

In a further aspect the present invention may be said to be a system for installing and/or removing a wind turbine blade to or from a rotor head of a nacelle located on top of a tower of a wind power generator, the system comprising
a. support cable or rope able to support the blade in a vertical condition and hoist and/or lower said blade from a location above the blade,
b. at least one carriage to locate intermediate the blade and the tower and be removably secured to the blade and be in contact with an outer surface or surfaces of the tower as the blade is hoisted and/or lowered by the support cable, said at least one carriage comprising a mechanism that allows the relative position of the blade and the tower to be adjusted to position the blade root in alignment with a blade mounting flange of the rotor head so that root bolts are able to insert into the root bolt apertures, by adjusting the position of the blade relative to the tower using the at least one carriage.

In a further aspect the present invention may be said to be a system for installing and/or removing a wind turbine blade to or from a rotor head of a nacelle located on top of a tower of a wind power generator, the system comprising
a. support cable or rope able to support the blade in a vertical condition and hoist and/or lower said blade from a location above the blade,
b. at least one carriage to locate intermediate the blade and the tower and be removably secured to the blade and be in contact with an outer surface or surfaces of the tower as the blade is hoisted and/or lowered by the support cable,
c. a crane able to lift the blade and in concert with the support cable to cause the blade to transition between its vertical condition parallel and adjacent the tower and a horizontal condition distal more the tower.

Preferably the at least one carriage is an upper carriage secured to the blade during hoisting at or proximate the blade root.

Preferably said hoisting and/or lowering is by a support cable or rope able to releasably attach to the blade and/or the at least one carriage (preferably the upper carriage).

Preferably a crane is provided able to lift the blade and in concert with the support cable to cause the blade to transition between its vertical condition parallel and adjacent the tower and a horizontal condition distal more the tower.

Preferably the crane that can lift the blade.

Preferably the crane that can lift the blade at a location spaced from the hoist anchor.

Preferably location spaced apart, is defined by a lifting anchor of the blade.

Preferably the lifting anchor is located more proximate the blade tip than then where the hoisting of the blade occurs.

Preferably the at least one carriage is an upper carriage able to be secured to the blade during hoisting at or proximate the blade root and wherein the location spaced apart is defined by a second of said at least one carriage, secured to the blade more proximate the blade tip.

Preferably the crane comprises a lifting boom and a lifting cable or rope that extends from the lifting boom to the blade to lift the blade.

Preferably the crane is vehicle mounted.

Preferably in the horizontal condition, the blade and the at least one carriage are separated from the tower.

Preferably the crane and the support cable in concert suspend and move the blade from its horizontal condition to its hoisting condition.

Preferably at least two and preferably 3 carriages are provided to be releasably secured to the blade at spaced apart locations.

Preferably the at least one carriage comprises of wheels or bearings able to move on and over the surface of surfaces of the tower during said hoisting.

Preferably the wheels or bearings help prevent the blade, during hoisting from swinging relative to the tower.

Preferably the at least one carriage comprises of wheels or bearings able to move over the surface of surfaces of the tower and hold said blade at where the at least one carriage is secured to the blade at a predetermined distance from the tower.

Preferably the at least one carriage comprises of wheels or bearings able to move over the surface of surfaces of the tower and hold said blade at where the at least one carriage is secured to the blade at a predetermined radial position from the tower.

Preferably the at least one carriage comprises of wheels or bearings able to move over the surface of surfaces of the tower and hold said blade at where the at least one carriage is secured to the blade at a predetermined tangential position from the tower.

Preferably said at least one carriage comprising a mechanism that allows the relative position of the blade and the tower to be adjusted to position the blade root in alignment with a blade mounting flange of the rotor head so that root bolts are able to insert into the root bolt apertures, by adjusting the position of the blade relative to the tower using the at least one carriage

Preferably said mechanism is an at least two axis translation mechanism.

Preferably said mechanism is an at least two axis translation mechanism able to displace the blade radially and tangentially relative to the tower at said carriage.

Preferably the mechanism is able to cause the moving of the blade to insert the root bolts into the bolt apertures.

Preferably at least one carriage is adapted and configured to be in sliding or rolling contact with the tower during hoisting and/or lowering of the blade.

Preferably the hoisting and/or lowering occurs from a hoist point above the blade.

Preferably hoist point is fixed relative to the tower.

Preferably the hoist point is located such that there is a gravitational bias on the blade and its secured carriage(s) during hoisting towards the tower surface of surfaces.

Preferably a winch to hoist and/or lower the blade is supported by the ground on which the tower is supported.

Preferably a winch to hoist and/or lower the blade is secured by the ground on which the tower is supported.

Preferably a winch to hoist and/or lower the blade is secured to and on the ground on which the tower is supported.

Preferably the support cable or rope during hoisting extends from the blade or said at least one carriage upwardly to a hoist point.

Preferably the support cable or rope during hoisting extends from the blade or said at least one carriage upwardly to a hoist point and from the hoist point toward the ground to a hoist winch.

Preferably the system further comprises a support vehicle.

Preferably the support vehicle can support the blade.

Preferably the support vehicle can deliver the blade to or from a remote location to or from the wind power generator.

Preferably the support vehicle is road vehicle (e.g. by a truck).

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both.

The invention consists in the foregoing and also envisages constructions of which the following gives examples only.

### BRIEF DESCRIPTION OF THE DRAWINGS

The invention will now be described by way of example only and with reference to the drawings in which:

FIG. 1: shows a perspective view of an example wind turbine blade oriented horizontally prior to installation;

FIG. 2A: shows a perspective view of an example wind turbine tower awaiting installation of at least one of its blades;

FIG. 2B: shows a detailed perspective view of the nacelle of the example wind turbine tower of FIG. 2A;

FIG. 3A: shows a perspective view of an example first/upper carriage of an embodiment of a wind turbine installation system;

FIG. 3B: shows a perspective exploded view of the example first/upper carriage of FIG. 3A;

FIG. 4A: shows a perspective view of an example second carriage of an embodiment of a wind turbine installation system;

FIG. 4B: shows a perspective exploded view of the example second carriage of FIG. 4A;

FIG. 5: shows a perspective view of an embodiment of a wind turbine installation system about to begin lifting of a horizontally oriented wind turbine blade;

FIG. 6: shows a perspective view of the embodiment of a wind turbine installation system of FIG. 5 having lifted the blade from above ground level;

FIG. 7: shows a perspective view of the embodiment of a wind turbine installation system of FIG. 6 having lifted the blade further up;

FIG. 8: shows a perspective view of the embodiment of a wind turbine installation system of FIG. 7 having lifted the blade to almost a vertical orientation;

FIG. 9: shows a perspective view of the embodiment of a wind turbine installation system of FIG. 8 having lifted the blade into a vertical orientation;

FIG. 10A: shows a perspective view of the embodiment of a wind turbine installation system of FIG. 9 having lifted the blade to proximate the wind turbine rotor head;

FIG. 10B: shows a perspective detailed view of the embodiment of a wind turbine installation system of FIG. 10A with the wind turbine rotor head and nacelle sectioned for clarity;

FIG. 11A: shows a side view of an embodiment of a wind turbine installation system with force diagrams illustrated thereon;

FIG. 11B: shows a rear view of the embodiment wind turbine installation system of FIG. 11A as well as a cross-section therethrough;

### DETAILED DESCRIPTION

With reference to the above drawings, in which similar features are generally indicated by similar numerals, a wind turbine blade installation system according to a first aspect of the invention is generally indicated by the numeral 1000.

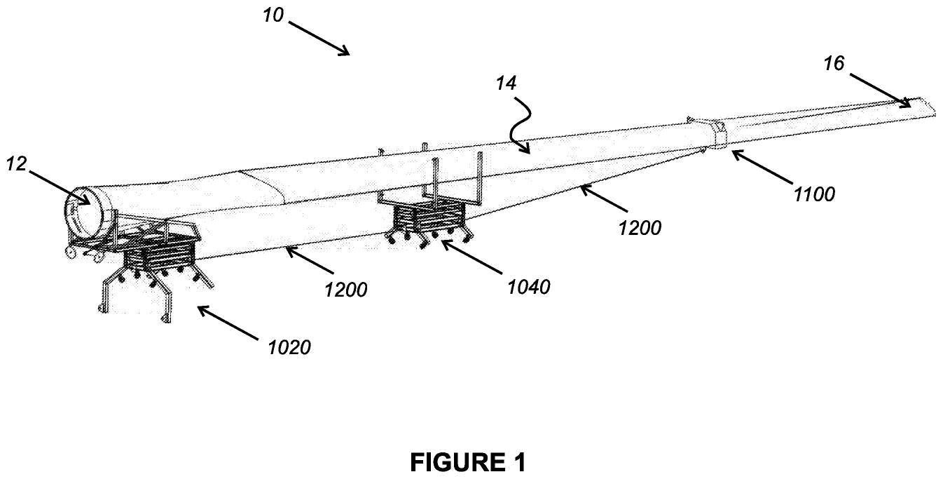

FIG. 1 shows an example wind turbine blade 10. The shape, length and configuration of the wind turbine blade 10 shown in FIGS. 1 to 11B and as described herein is exemplary only of a typical wind turbine blade, having a length of about 80 meters.

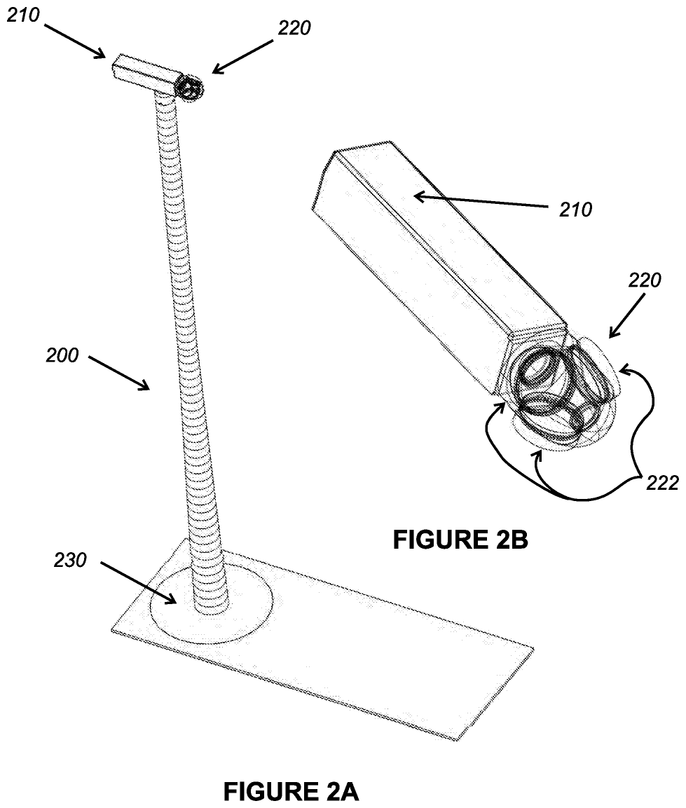

Likewise, an example wind turbine tower 200 is shown in FIG. 2A. The tower 200 is shown having its nacelle 210 and rotor head 220 already installed using known methods of wind turbine tower assembly and construction/erection. This tower 200 is only an example configuration of a wind turbine tower for which the system and methods described herein can be employed for connection of its blades thereto. It may as an example have a height of about 165 meters from the top surface of the nacelle 210 to its foundation 230.

FIG. 2B shows the rotor head 220 of the tower 200 being transparent to illustrate three apertures or blade mounting flanges 222, corresponding to three blades to be installed thereto. These blade mounting flanges 222 are shown having an annular ring with root bolt apertures 224.

Generally, the blade 10 has an uppermost blade root 12, a central portion 14 and a blade tip 16. The root 12 generally may have a substantially cylindrical or tubular configuration, as shown in FIG. 1, where an annular ring of root bolt apertures 12A extend circumferentially about the root 12. Other shaped roots are known in the art, and could be adapted for use in the system and methods described herein by those skilled in the art.

The term ‘bolt’ as used herein merely as one example of means used to couple together the blade mounting flange 222 of the rotor head 220 of the wind turbine nacelle 210. Other fastening means may be employed known to those skilled in the art depending on the specific configurations of the wind turbine 200 as whole, the nacelle 210, its rotor head 220, the blade mounting flange(s) thereof 220, and/or the root configuration of a given blade 10.

The blade is shown in FIG. 1 in a substantially horizontal orientation. Generally, this may be understood to be the condition in which the blade 10 arrives on-site delivered by a transportation vehicle, for subsequent erection and installation. The blade 10 may arrive on-site using a support vehicle, such a multi-wheeled truck having a flatbed support rack. It may be transported near the foundation of the tower in a substantially horizontal condition.

Shown removably secured to the blade 10 in FIG. 1 are a plurality of carriages 1020, 1040. These carriages 1020, 1040 may form part of the system 1000 described below, but are only exemplary means of how one may configure the system and carriage(s) thereof. The carriages may be secured to the blade 10 while it rests on the support rack/flatbed of the support vehicle/truck once it arrives on-site, may be secured to the blade 10 prior to its arrival on said support rack/flatbed of the support vehicle/truck (i.e., the blade 10 arrives on-site with the carriage pre-arranged thereon) and/or may be secured to the blade 10 after the blade is lifted or otherwise moved off/from the support rack/flatbed of the support vehicle/truck and onto the ground at/near the foundation of the tower.

Generally, at least one carriage is employed in the system 1000 described herein and is provided to assist in moving the blade 10 from its substantially horizontal condition to a substantially vertical orientation, where the blade root 12 is oriented upwardly and higher than the blade tip 16 oriented downwardly, as shown and described in relation to FIGS. 1 to 11B

However, in FIG. 1, an exemplary embodiment of the system 1000 is shown in which two carriages are employed, a first or upper carriage 1020, and a second or intermediate carriage 1040.

Generally, at least an upper carriage 1020 is employed by the system 1000 at or proximate the blade root 12, however second, third or even more carriages may be advantageous to employ depending on the length or other features of the blade 10 to be installed.

The second or intermediate carriage 1040, when employed in combination with the first or upper carriage 1020, is generally placed at or proximate the central portion 14 of the blade 10, between the root 12 and tip 16. However, more generally, it may be placed anywhere along the blade 10, spaced apart from the blade root 12 at where the first carriage 1020 is placed, and generally more towards or proximate the blade tip 16 than said first carriage 1020.

Also shown in FIG. 1 is a lifting anchor 1100 placed at a location spaced apart the first and second carriages 1020, 1040, at or proximate the blade tip 16.

Those skilled in the art will appreciate that the number of, and positions of, the carriages, and the lifting anchor 1100, employed in the systems and methods described herein are variable and may depend on any number of design, installation and engineering considerations, such as in particular, optimising balance/centre of gravity and reducing swaying/rotation of the blade 10 during lifting.

For instance, in the example embodiment shown where two carriages are employed, the first or upper carriage 1020 is generally provided at the blade root 12, with the second carriage 1040 provided at the central portion 14, and the lifting anchor 1100 provided at or near the blade tip 16.

However, in another embodiment, only a first carriage 1020 may be employed at the blade root 12, with no second carriage, and the lifting anchor 1100 provided at or near the blade tip 16. In such a case, the first carriage 1020 and lifting anchor 1100 positions may vary from those shown in FIG. 1 so as to achieve a different centre of gravity when lifting the blade 10.

Similarly, in another embodiment, only a first and second carriage 1020, 1040 may be employed, with no lifting anchor 1100 provided. In such a case, the second carriage 1040 may be moved further toward the blade tip 16, once more to achieve a different centre of gravity when lifting the blade 10.

FIG. 1 also shows two tensioning cables 1200, one extending taught between the first carriage 1020 to the second carriage 1040 and the other extending from the second carriage 1040 to the lifting anchor 1100. Such tensioning cables 1200 may be employed to help keep the blade 10 generally aligned as it is being lifted, i.e., reducing yawing/rotation about the elongate axis of the blade 10.

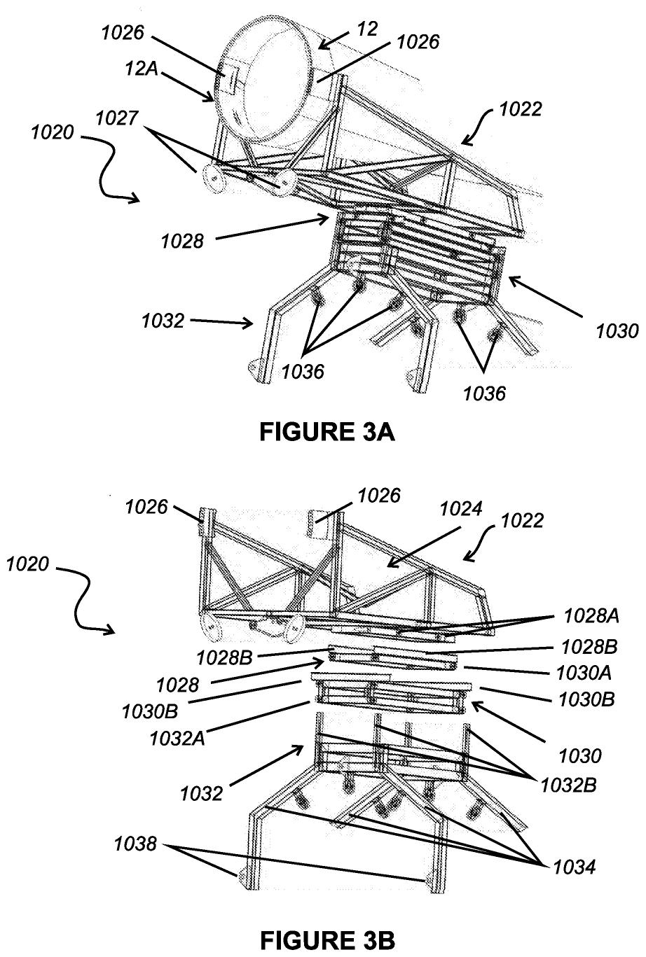

FIGS. 3A and 3B show detail views of an example embodiment of the first carriage 1020. In FIG. 3A the first or upper carriage 1020 is shown connected to the blade 10, whereas FIG. 3B shows an exploded view of the upper carriage 1020 in and of itself.

The first or upper carriage 1020 generally comprises of a mounting structure 1022, taking the form of a truss 1024 having two mounting flanges 1026 that connect to the root 12 of the blade 10. In particular the mounting flanges 1026 are configured (shaped/dimensioned) to match and thereby connect to the annular ring of root bolt apertures 12A of the blade root 12. Any number of mounting flanges 1026 may be provided and arranged in various ways about the root 12 of the blade 10. However, here there is shown two mounting flanges 1026 arranged at opposite ends of the root 12 circumference.

FIG. 3B shows an at least two axis translation mechanism of the carriage 1020, in particular a three-axis translation mechanism comprising:
fore-aft translation structure 1028, which allows the mounting structure 1022 to translate forwards and backwards relative said fore-aft translation structure 1028 via, for example, rollers 1028A mounted in between rails 1028B;
lateral translation structure 1030, which allows the fore-aft translation structure 1028 to translate laterally (left to right) relative said lateral translation structure 1030 via, for example, rollers 1030A mounted in between rails 1030B; and
guiding structure 1032, which allows the lateral translation structure 1030 to translate vertically (up and down) relative said guiding structure 1032 via, for example, rollers 1032A mounted in between rails 1032B.

The embodiment three-axis translation mechanism is exemplary only, and many other structures and means other than rollers/rails could be employed to provide three-axis translation of the carriage 1020, such that, the position of the blade 10 (i.e., of the mounting structure 1022 which connects to the blade 10) relative the tower 200 (i.e., of the guiding structure 1032 which contacts the tower 200 surface thereby guiding the blade 10 up the tower 200) to be adjusted.

To that end, the guiding structure 1032 comprises of a plurality of guiding legs 1034, configured depending on the expect outer diameter(s) of the tower 200 to generally extend around the outer periphery of the tower 200. As such, mounted to the guiding legs 1034 are a plurality of rollers 1036 which may contact the outer periphery/surface(s) of the tower 200 so as to provide rolling or sliding contact and thus movement of the carriage 1020 as a whole up the tower 200 as the blade 10 is being lifted. Mounted to extremities of the forward-most guiding legs 1034 are hoisting points 1038 to which by a support cable or rope 1400 may be releasably attached. Mounted to the rear of the guiding structure 1032 is hoisting point (not shown) to which the tensioning cables 1200 described above can connect.

FIG. 3A also shows support rollers 1027 which may be first to contact the outer periphery/surface(s) of the tower 200 and thus assist in providing rolling or sliding contact and thus movement of the carriage 1020 as a whole. In some embodiments, these support rollers 1027 may be drive by motors and the like to assist in said initial movement of the carriage 1020 up the tower 200.

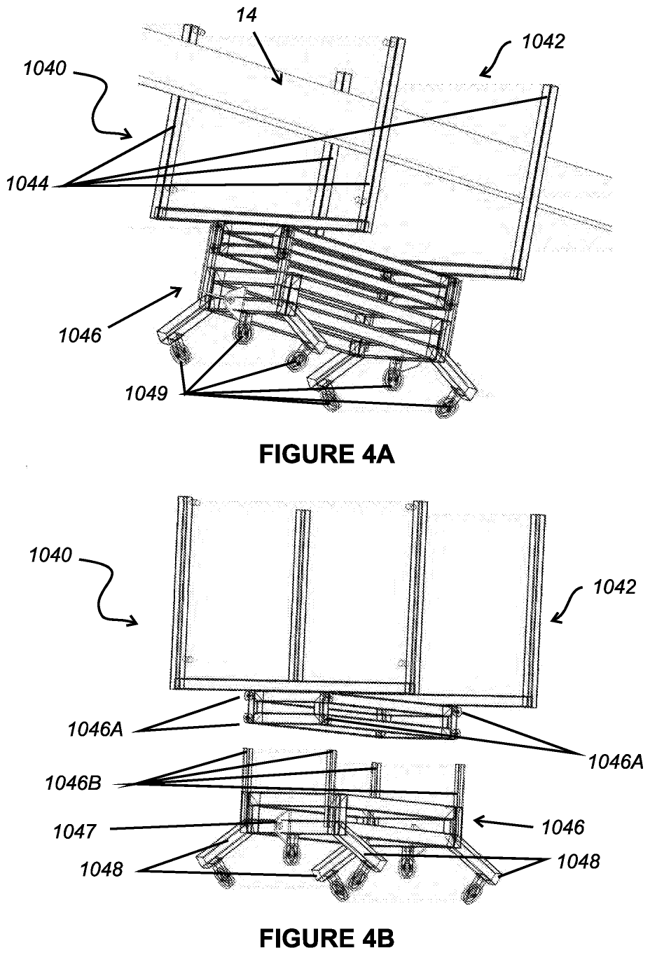

FIGS. 4A and 4B show detail views of an example embodiment of the second carriage 1040. In FIG. 4A the second carriage 1040 is shown connected to the blade 10, at or proximate the central portion 14, whereas FIG. 4B shows an exploded view of the second carriage 1040 in and of itself.

The second carriage 1040 generally comprises of a mounting structure 1042, taking having mounting legs 1044 that connect to the central portion 14 of the blade 10. This may be via direct connection (i.e., using fasteners etc.) or via e.g. ratcheted straps, tensioned cables or the like, or any other suitable means of coupling said mounting legs 1044 to surfaces or anchors of the central portion 14 of the blade 10.

FIG. 4B shows an angular pivoting mechanism of the carriage 1040, in particular a guiding structure 1046, which allows the mounting structure 1042 to translate vertically (up and down) relative said guiding structure 1046 via, for example, rollers 1046A mounted in between rails 1046B. Thus, by changing the vertical position of the mounting structure 1042 relative the guiding structure 1046, the overall pitch angle (i.e., the angle of the elongate axis of the blade 10 relative the elongate axis of the tower 200) can be varied.

The embodiment angular pivoting mechanism is exemplary only, and many other structures and means other than rollers/rails could be employed to provide angular pivoting of the carriage 1040, such that, the angular pitch/position of the central portion 14 of the blade 10 (i.e., of the mounting structure 1042 which connects to the central portion 14) relative the tower 200 (i.e., of the guiding structure 1046 which contacts the tower 200 surface thereby guiding the blade 10 up the tower 200) to be adjusted.

To that end, the guiding structure 1046 comprises of a plurality of guiding legs 1048, configured depending on the expect outer diameter(s) of the tower 200 to generally extend around the outer periphery of the tower 200. As such, mounted to the guiding legs 1048 are a plurality of rollers 1049 which may contact the outer periphery/surface(s) of the tower 200 so as to provide rolling or sliding contact and thus movement of the carriage 1040 as a whole up the tower 200 as the blade 10 is being lifted. Mounted to the rear and front of the guiding structure 1046 are hoisting points 1047 to which the tensioning cables 1200 described above can connect.

The lifting system 1000, and related example lifting processes and methods will now be described.

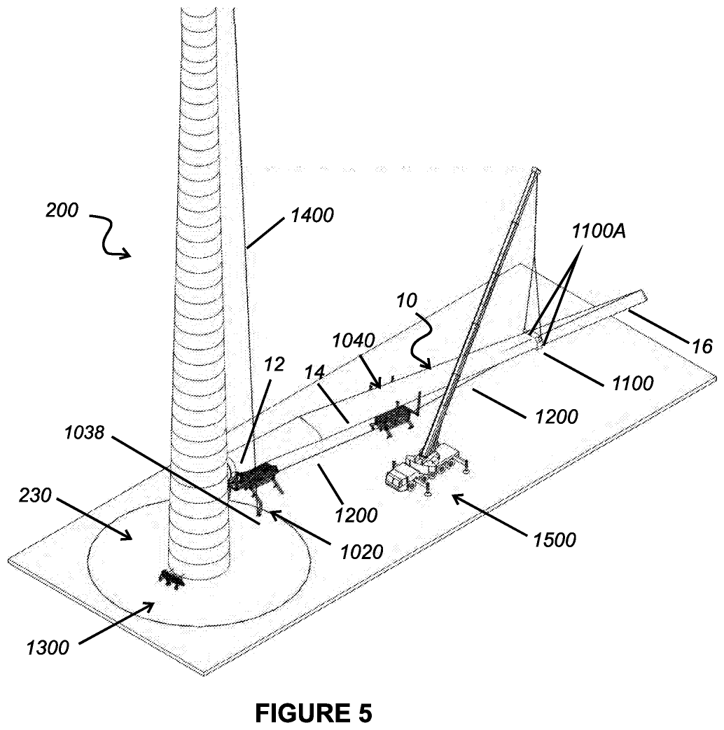

FIG. 5 shows an initial starting point of lifting, whereby the blade 10 is in its horizontal condition. Located on the foundation 230 and opposite the end of the rotor head 220 of the nacelle 210 of the tower, is a winching arrangement 1300. This winching arrangement may comprise of any suitable lifting means, i.e., two winches as shown. The hoisting means, e.g. tensioned cables 1400 thereof extend from said winching arrangement 1300 into the interior of the tower 200, upwards therethrough and to the top of the tower 200.

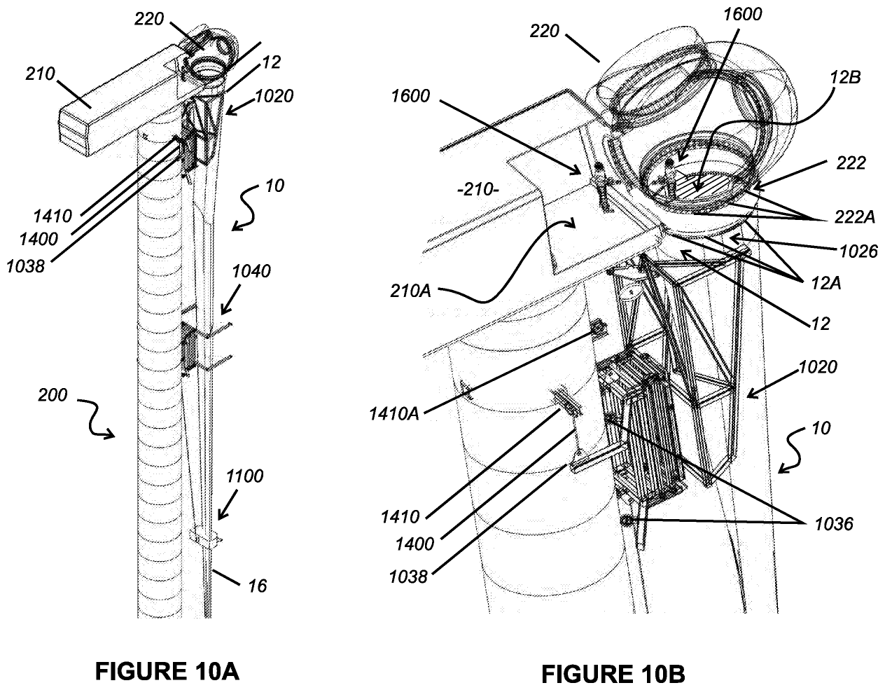

The cables 1400 then extend and escape outwardly from the walls of the tower 200, proximate and underneath the nacelle 210 thereof. This is shown in FIG. 10B whereby the cables 1400 extend out from lateral sides of the tower 200 to idle pulleys 1410. These idle pulleys 1410 are positioned such that the hoisting cables 1400 extending downwardly therefrom are about aligned to the hoisting points 1038 of the forward-most guiding legs 1034 of the first or upper carriage 1020.

It is by way of these hoisting means, e.g. tensioned cables 1400 that lift the first carriage 1020 up the tower 200, that the blade 10 is lifted.

In some embodiments, the winching arrangement 1300 may be provided within the interior of the tower 200 itself, but still at ground/foundation level, with its hoisting means, e.g. tensioned cables 1400 extending upwardly to the top of the tower 200.

In other embodiments, the winching arrangement 1300 may instead be provided directly beneath the nacelle 210, within the interior of the tower 200, with its hoisting means, e.g. tensioned cables 1400 extending downwardly to aforementioned idle pulleys 1410.

Those skilled in the art will envisage variations of where to position the winching arrangement 1300 and how to route the cables thereof, i.e., the winches may even be mounted at the top of the tower 200, in lieu of said idle pulleys 1410.

However, it is generally preferable that the cables 1400 extend from near the nacelle 210, so that as the blade is being lifted, it can be brought as close as possible to the rotor head 220 of the tower 200.

It is also generally preferable that the cables be mostly routed through the interior of the tower 200, so as to avoid or reduce them swaying as experienced by cables/cranes in the typically high-wind wind turbine installation fields/farms. This may thereby reduce risk and assisting in final alignment of the blade 10 with the rotor head 210.

Also shown in FIG. 5 is a supplementary crane 1500 that is provided to lift up the rear, or tip 16 end of the blade 10, via the aforementioned lifting anchor 1100. This crane 1500, which is shown as a vehicle mounted crane but could otherwise by a stand-alone installation, is provided to keep the tip 16 of the blade 10 from pivoting down too much and thus contacting/impacting the ground while the blade 10 tilts upwardly from hoisting of the first carriage 1020 up the tower 200.

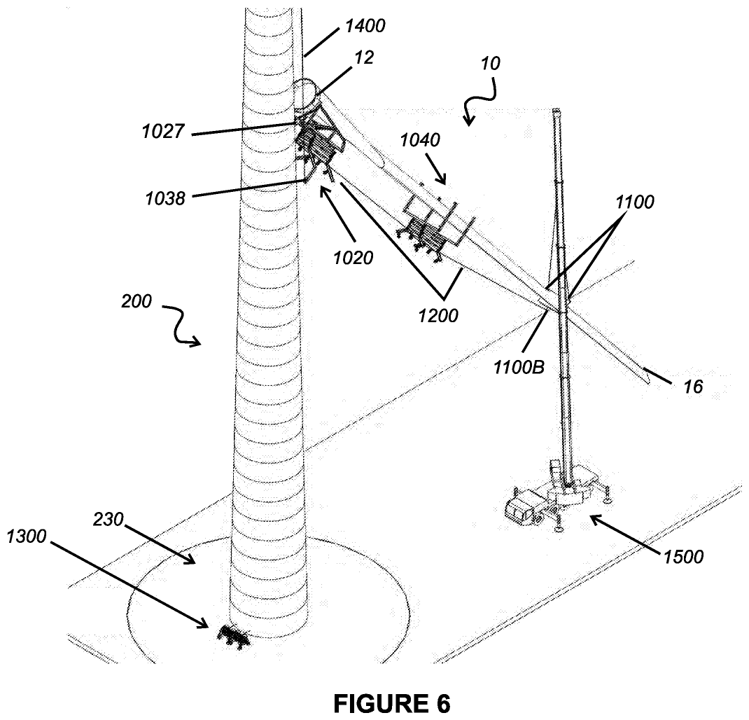

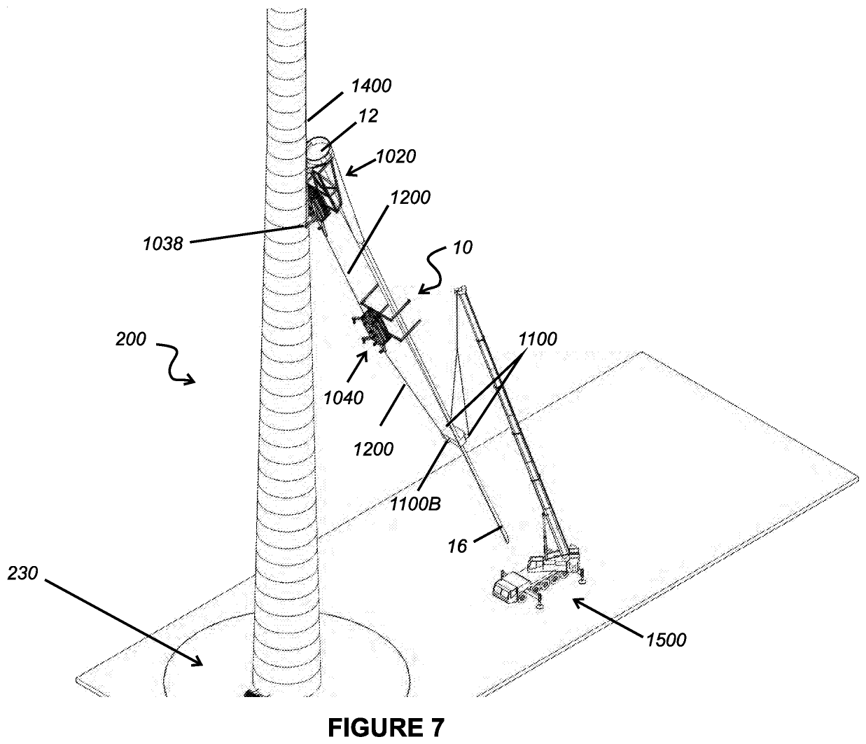

The lifting anchor 1100 is shown throughout the figures arranged about the blades 10 periphery, and having two upper hoisting points 1100A thereabove, to which a cable of the crane 1500 connects, and a lower hoisting point 1100B 1040 (visible in FIGS. 6 and 7) to which the tensioning cables 1200 described above can connect it to the second or intermediate carriage.

Those skilled in the art will appreciate that in some embodiments, a lifting anchor 1100 may not be needed, and a second, third, fourth etc. carriage can simply be moved further toward the blade tip 16, with the crane 1500 connecting thereto to assist in suspension of the blade tip 16.

Further, in some embodiments, the lifting anchor 1100 may be provided with a wheeled or roller arrangement so as to assist in its guidance up the surfaces of the tower 200.

However, generally, the extent to which the first carriage 1020 extends ‘down’ (relative the blades horizontal condition) from the blade root 12 means that often the blade tip 16 may not at all contact the tower 200 during lifting.

FIG. 6 shows the blade 10 having been lifted upward from its position in FIG. 5. The angle of the blade 10 is not yet such that the plurality of rollers 1036 are contacting the surface(s) of the tower 200, however, the support rollers 1027 located higher up and more-forward on the carriage 1020 are in contact with the tower 200. The crane 1500 can be seen to have lifted (vie lifting anchor 1100) the tip end 16 of the blade 10 higher than in FIG. 5.

In FIG. 7 the blade 10 is higher up, and the angle (pitch) thereof relative the tower 200 is such that at least some of the plurality of rollers 1036 of the first or upper carriage 1020 are now in contact with the tower 200.

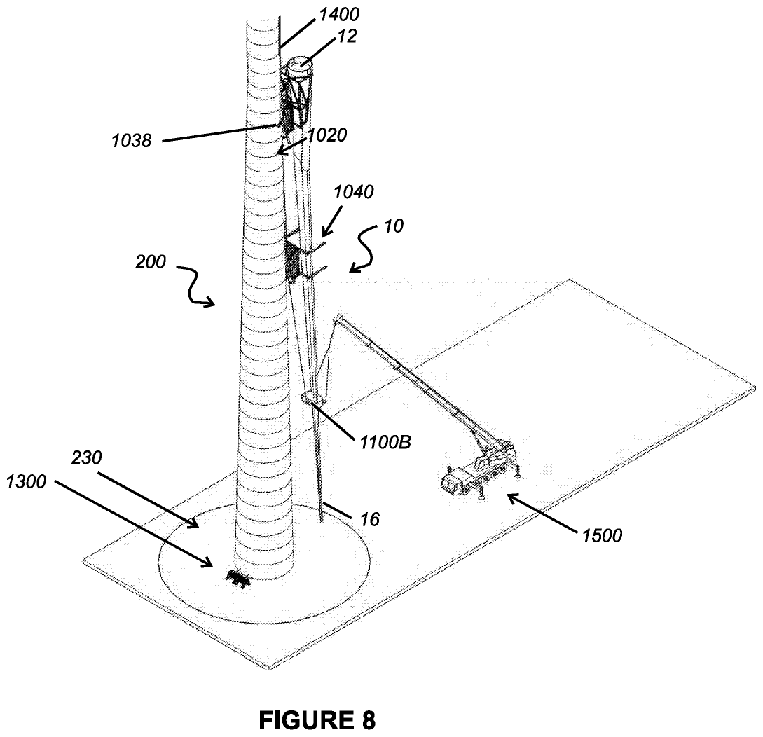

In FIG. 8 the blade 10 is now almost at a substantially vertical and upright orientation or condition, whereby the blade root 12 is substantially above and in-line (vertically) with the blade tip 16, and with all the rollers of the plurality of rollers 1036 of the first or upper carriage 1020, and all the rollers of the plurality of rollers 1049 of the second carriage 1040, substantially in contact with surface(s) of the tower 200.

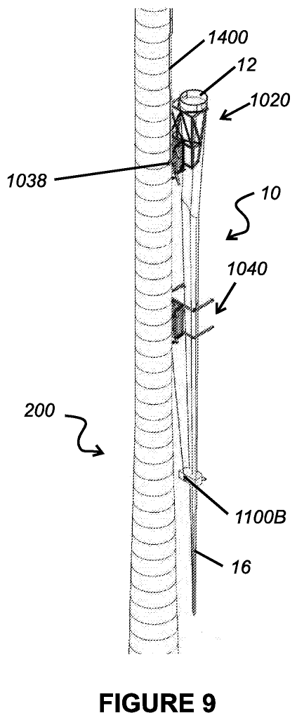

In FIG. 9 the blade 10 is at sufficient height that the crane 1500 need no longer be employed. Further, the blade 10 is now at its substantially vertical condition, whereby the blade root 12 is above and in-line (vertically) with the blade tip 16. The hoisting means 1400 are now lifting the blade 10 through the final stretch towards the nacelle 210.

Finally, in FIG. 10A, the blade 10 has reached its end-point, whereby the root end 12 thereof is proximate the blade mounting flange 222 of the rotor head 220 of the wind turbine nacelle 210.

A detailed view of this is seen in FIG. 10B, whereby a section is taken through the front of the turbine nacelle 210 and the rotor head 220, to show worker(s) 1600 (one supported atop the nacelle interior floor 210A, and the other supported atop a flat deck 12B removably mounted within the root 12 of the blade 10). These worker(s) 1600 (which may be of any required number) may cooperate within the interior(s) of the blade root 12, the nacelle 210 and/or the rotor head 220, to align the apertures 222A of the blade mounting flange 222 of the rotor head 220 with the annular ring of root bolt apertures 12A of the blade root 12.

Once aligned, the root bolts may be passed through both sets of apertures 12A, 222A and fastened to complete installation of the blade 10 onto the rotor head 210.

In some instances, it may be required that minor adjustments be made to the blade 10 position so as to completely align both sets of apertures 12A, 222A.

This may be done in a number of ways. Slack may be given to the hoisting cables 1400 so as to permit minor movement of the blade 10. Further, more or less tension may be provided at one winch of the winch arrangement 1300 compared to the other winch, so as to effect a corresponding increase/decrease in tension or length of one hoisting cable 1400 relative the other. This may cause a slight sagging of the blade 10 at one side thereof once more permitting more some. Movement of the blade 10 in both these instances may be actioned by the worker(s) 1600, since the suspended blade 10 may not require more than manual labour to move small increments at such a height (e.g., the worker(s) 1600 within the nacelle 210 may pull the blade towards themselves, with the worker(s) 1600 within the rotor head 210 and atop the temporarily deck 12B assisting in this maneuverer).

Those skilled in the art may envisage other means of assisting alignment of the apertures 12A, 222A, such as, for instance, placing alignment rails on the blade mounting flange 222 of the rotor head 220 and corresponding guide rails on the blade root 12, such that as the root 12 approaches the rotor head 220, the alignment and guide rails cooperate and bring the two into correct coaxial alignment.

Further, in some embodiments, the plurality of rollers 1036 of the first or upper carriage 1020, and the plurality of rollers 1049 of the second carriage 1040 may be actuatable (i.e., the rotational positions thereof may be movable remotely) and may even be driven by motors, sufficient to provide only minor movements necessary to make the requisite minor adjustments to the blade 10 position.

In other words, modifications can be made to the rollers of the carriage(s) so that they not only passive provide sliding or rotational contact between the carriage(s) and tower 200 surface(s), but also provide activatable and controllable movement via motors and the like driving said rollers. Actuation jacks may also be provided extending from the carriage(s) and configured to push against the surfaces of the tower 200, to adjust the pitch angle of the blade 10 as necessary.

Further, while the roller and rail configurations of the three-axis translation mechanism of the first or upper carriage 1020 and of the angular pivoting mechanism of the second carriage 1020 may be passive, and thus slack so as to permit free movement of the various sub-structures of the carriage(s), they may instead also be actuated or driven, such that minor movements of the blade 10 can be effected from a remote location, to assist in final alignment of the apertures 12A, 222A.

It will be noted that FIG. 10B also shows a front positioned idle pulley 1410A. This may used (when a tensioned cable 1400 of the winching arrangement 1300 is routed therethrough) to couple to a coupling point in between the support rollers 1027 of the first or upper carriage 1020, in the very initial-most stages of lifting of the blade 10 (i.e., at or before the position shown in FIG. 5).

It will be appreciated that this may be done in conjunction with routing further cables 1400 through the lateral idle pulleys 1410. Any number of hoisting cables 1400 can be used, and any number of idle pulleys 1410, at various circumferential positions underneath the nacelle 210, to lift the first or upper carriage 1020.

It will also be appreciated that, prior to final coupling/fastening of the root bolts through the apertures 12A, 222A, the mounting flanges 1026 that connect to the root 12 of the blade 10 must be at least partially disconnected therefrom, so they do not inhibit the final pressing together of the root 12 with the blade mounting flange 222. For instance, some of the root bolts may first be partially fastened, the mounting flanges 1026 that connect to the root 12 then disconnected, after which the blade is supported by the partially fastened root bolts, then all root bolts positioned and fully fastened to complete installation of the blade 10.

The overall dimensions and geometries of the carriage(s) may be adjusted on a case by case basis to assist in appropriate distancing and alignment of the blade 12 root and tip 16 relative the tower 200. For instance, in relation to the first carriage 1020, the distance between the hoisting points 1038 (to which the hoisting cables 1400 connect) and the mounting flanges 1026 (and/or other means to which the root 12 of the blade connect) may determine the off-set distance of the blade root 12 relative the surface(s) of the tower 200 as it approaches it's final alignment and installation position.

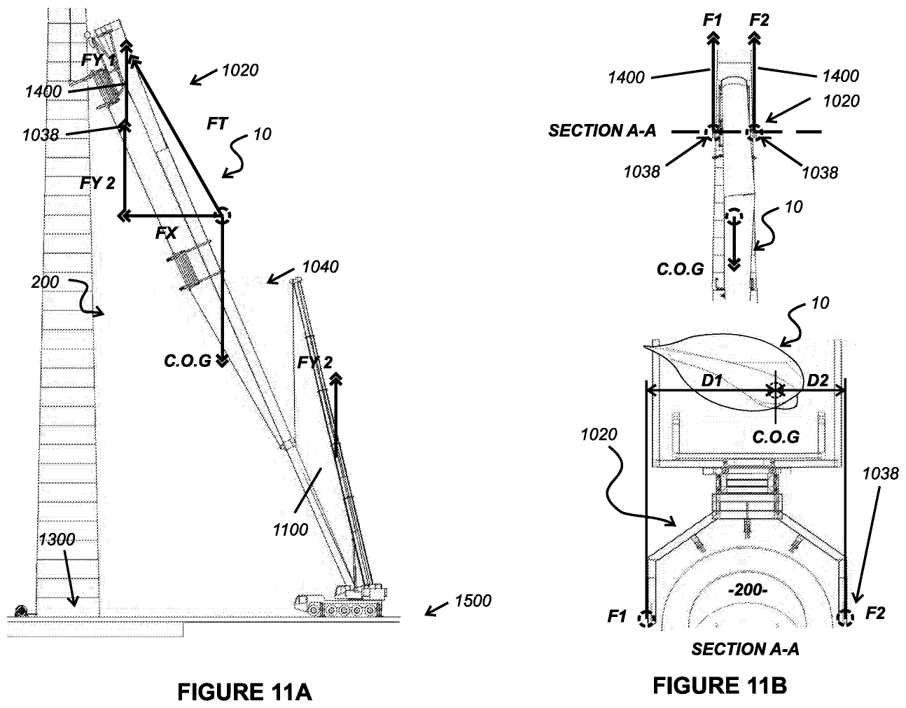

FIGS. 11A and 11B illustrate at least some of the force considerations that may be configured by one skilled in the art when employing the system and methods described herein.

FIG. 11A shows a schematic force diagram of the various forces that may need to be resolved during lifting of the blade 10, before it reaches its substantially vertical condition of FIG. 9. Extending upwardly from the hoisting points 1038 to which the hoisting cables 1400 connect to the first or upper carriage 1020 is a first vertical lifting force FY1. Similarly, extending upwardly from the lifting anchor 1100 hoisting point(s) 1100A to which the crane 1500 may connect is a second vertical lifting force FY2. These two upward vertical lifting forces must counteract the downwards gravity force of the blade's weight acting at about it's centre of gravity C.O.G (the position of which in FIGS. 11A and 11B is exemplary only). There is also a component of horizontal force created by the angled pitch of the blade 10, labelled as FX, and thus, an angular component of the total force may be represented by FT.

These various forces FX, C.O.G, FT, FY1 and FY2 must all be resolved by way of appropriate configuration of the tension/lifting force imparted by the hoisting cables 1400, as well as in some embodiments, by the crane 1500. In some instances, the crane 1500 may not be a significant contributor to upward vertical lifting force, and so may be considered negligible. However, generally most of these forces must be balanced to ensure a gradual and smooth transition of the blade 10 from a substantially horizontal condition of FIG. 5 to a substantially vertical condition of FIG. 9.

It should also be noted that a moment about the blades 10 centre of gravity C.O.G may also be created due to the distance therefrom that the first and second vertical lifting forces FY1, FY2 may act to rotate the blade in opposite directions (i.e., FY1 may rotate the blade 10 clockwise where's FY2 may rotate the blade 10 counter-clockwise, relative FIG. 11A). Thus, one skilled in the art may also need to consider how the vertical lifting forces FY1, FY2 may alter the pitch angle of the blade 10 itself.

To that end, the skilled person may appreciate that changes in the blade 10 position actioned by means of the three-axis translation mechanism of the first or upper carriage 1020, as well as by means of the angular pivoting mechanism of the second carriage 1040, can be used to carefully adjust the blades 10 position during its transition from a substantially horizontal condition of FIG. 5 to a substantially vertical condition of FIG. 9, to mitigate at least some of these force and moment considerations.

FIG. 11B also illustrates how changes to the tension in each hoisting cable 1400 (in embodiments where two extend down from idle pulleys 1410 at lateral sides of the tower 200 and connect to hoisting points 1038 of the carriage 1020) may be effected to counteract the off-set centre of gravity C.O.G typically of wind turbine blades 10. As can be seen, the C.O.G may not necessarily be positioned at a centre of the blade (i.e., directly through its elongate axis), and instead may be biased towards the thicker frontal leading-edge of the blade 10.

Thus, F1 and F2 vertical lifting forces of each hoisting cable 1400 may need to be adjusted to account for the moment created by their different distances to said off-set centre of gravity C.O.G. Section A-A also illustrates these differences in distances of F1 and F2 to C.O.G., shown as D1 and D2 when viewed from a section extending across the hoisting points 1038 of the carriage 1020 to which the hoisting cable 1400 connect and lift the blade 10.

It should be noted that, the aforementioned examples of various aspects of the system and methods described herein may be configured to adjust the blade's position during final alignment of both sets of apertures 12A, 222A, may be equally employed by those skilled in the art when resolving the force considerations described above in relation to FIGS. 11A and 11B.

The system 1000 and methods described herein may therefore provide a safe and cost-effective means of lifting and installing wind turbine blades, whereby:
the internal routing of the cables 1400 responsible for blade lifting and the disposing thereof from idle pulleys 1410 at just beneath the nacelle reduce the issues of swaying associated with (often multiple) high-reaching cranes supported at ground level;
the guiding of the blade 10 up the tower 200 surfaces via carriages removably secured thereto (and positioned intermediate the blade 10 and tower 200) help to keep the blades centre of gravity as close to the tower 200 at all times and as close to the primary lifting means (hoisting cables 1400) at all times, compared to awkward high-reaching cranes or purely horizontal air-lifting methods previously employed;
only a low-reaching crane 1500 may be needed at times only to keep the blade tip 16 from contacting the ground during its angle change, which, together with the use of carriage(s), greatly reduces costs compared to utilising multiple high-reaching cranes or air-lifting means.

It will also be appreciated that an inverse or reverse order of the methods/systems described above may be employed in removal or uninstallation of a blade 10 from a rotor head 210. For example:
a carriage may be lifted up to the top of the nacelle by winching arrangement as described above;
the carriage may be aligned with the blade 10, and connected thereto;
the root 12 of the blade disconnected from the rotor head 210 (e.g. by workers 1600 positioned therein) to then move the weight of the blade 10 from the rotor head 210 to the carriage and hoisting cables 1400;
the blade 10 then lowered, in a fashion similar but inverse to the movement thereof shown in FIGS. 5 to 10, with a supplementary crane 1500 located at ground level ready to connect to or near the tip 16 of the blade 10;
said crane connecting to said tip 16 of the blade 10, the hoisting cables 1400 lowering the carriage, and the blade moving from its substantially vertical condition back to a substantially horizontal condition, as in FIG. 1;
the blade 10 lowered onto the ground for maintenance/repair and/or onto the flat bed of a support vehicle and the like, for transportation off-site as desired.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

1. A method for installing a wind turbine blade to a rotor head of a nacelle located on top of a tower of a wind power generator, the method comprising:
a. hoisting the blade up the tower in an orientation presenting the blade root uppermost and the blade extending substantially vertically, guided by the tower by at least one carriage intermediate the blade and the tower and that is removably secured to the blade and that is in contact with an outer surface or surfaces of the tower as the blade is hoisted,
b. positioning the blade root in alignment with a blade mounting flange of the rotor head so that root bolts are able to insert into the root bolt apertures, by adjusting the position of the blade relative to the tower using the at least one carriage,
c. moving the blade to insert root bolts into the bolt apertures, and
d. securing the blade to the rotor head using the root bolts.

2. A method as claimed in claim 1 wherein the at least one carriage is an upper carriage secured to the blade during hoisting at or proximate the blade root.

3. A method as claimed in claim 1 or 2 wherein said hoisting is by a support cable or rope releasably attached to the blade and/or the at least one carriage (preferably the upper carriage).

4. A method as claimed in any one of claims 1 to 3 wherein the method further comprises, prior to said hoisting, attaching a support cable or rope to (preferably an anchor such as a hoist anchor of) the blade and/or at least one carriage.

5. A method as claimed in any one of claims 1 to 4 wherein the method comprises, prior to said hoisting, attaching a support cable or rope to the blade and/or at least one carriage when the blade, with said at least one carriage secured to it, is in a substantially horizontal condition supported by ground adjacent the tower.

6. A method as claimed in claim 5 wherein the blade, prior to said hoisting, is supported by the ground on a support vehicle or support rack.

7. A method as claimed in claim 5 or 6 wherein the blade is transitioned from its horizontal condition to its vertical tower guided hoisting condition by a crane.

8. A method as claimed in any one of claims 5 to 7 wherein the blade is transitioned from its horizontal condition to its vertical tower guided hoisting condition by a crane that can lift the blade.

9. A method as claimed in any one of claims 5 to 8 wherein the blade is transitioned from its horizontal condition to its vertical tower guided hoisting condition by a crane that can lift the blade at a location spaced from the hoist anchor.

10. A method as claimed in claim 9 wherein the location spaced apart, is defined by a lifting anchor of the blade.

11. A method as claimed in claim 10 wherein the lifting anchor is located more proximate the blade tip than then where the hoisting of the blade occurs.

12. A method as claimed in claim 9 wherein the at least one carriage is an upper carriage secured to the blade during hoisting at or proximate the blade root and wherein the location spaced apart is defined by a second of said at least one carriage, secured to the blade more proximate the blade tip.

13. A method as claimed in any one of claims 7 to 12 wherein the crane comprises a lifting boom and a lifting cable or rope that extends from the lifting boom to the blade to lift the blade.

14. A method as claimed in any one of claims 7 to 12 wherein the crane is vehicle mounted.

15. A method as claimed in claim 5 wherein, in the horizontal condition, the blade and the at least one carriage are separated from the tower.

16. A method as claimed in any one of claims 7 to 15 wherein the crane and the support cable in concert suspend and move the blade from its horizontal condition to its hoisting condition.

17. A method as claimed in any one of claims 7 to 15 wherein the crane and the support cable in concert suspend and move the blade from its horizontal condition to its hoisting condition by bringing the at least one carriage in contact with an outer surface or surfaces of the tower.

18. A method as claimed in any one of claims 7 to 17 wherein the crane is disconnected from the blade once the blade is vertical and the at least one carriage is located against the tower.

19. A method as claimed in any one of claims 7 to 18 wherein the crane is disconnected from the blade once the blade is fully suspended only by the hoisting cable or rope.

20. A method as claimed in any one of claims 1 to 19 wherein in the hoisting condition, at least two and preferably 3 carriages are releasably secured to the blade at spaced apart locations, are guided by the tower located intermediate the blade and the tower.

21. A method as claimed in any one of claims 1 to 20 wherein in the hoisting condition, and upper carriage is releasably secured to the blade at or proximate the blade root, a lower carriage is releasable secured to the blade proximate the blade tip and independent from the upper carriage.

22. A method as claimed in any one of claims 1 to 21 wherein the at least one carriage comprises of wheels or bearings able to move on and over the surface of surfaces of the tower during said hoisting.

23. A method as claimed in claim 22 wherein the wheels or bearings help prevent the blade, during hoisting from swinging relative to the tower.

24. A method as claimed in any one of claims 1 to 23 wherein the at least one carriage comprises of wheels or bearings able to move over the surface of surfaces of the tower and hold said blade at where the at least one carriage is secured to the blade at a predetermined distance from the tower.

25. A method as claimed in any one of claims 1 to 24 wherein the at least one carriage comprises of wheels or bearings able to move over the surface of surfaces of the tower and hold said blade at where the at least one carriage is secured to the blade at a predetermined radial position from the tower.

26. A method as claimed in any one of claims 1 to 25 wherein the at least one carriage comprises of wheels or bearings able to move over the surface of surfaces of the tower and hold said blade at where the at least one carriage is secured to the blade at a predetermined tangential position from the tower.

27. A method as claimed in any one of claims 1 to 26 wherein the positioning of the blade is achieved by said at least one carriage.

28. A method as claimed in any one of claims 1 to 27 wherein said at least one carriage (preferably at least said upper carriage) comprises a mechanism that allows the relative position of the blade and the tower to be adjusted.

29. A method as claimed in claim 28 wherein said mechanism is an at least two axis translation mechanism.

30. A method as claimed in claim 28 wherein said mechanism is an at least two axis translation mechanism able to displace the blade radially and tangentially relative to the tower at said carriage.

31. A method as claimed in any one of claims 28 to 30 wherein the mechanism is able to cause the moving of the blade to insert the root bolts into the bolt apertures.

32. A method as claimed in claim 1 wherein the at least one carriage is in sliding or rolling contact with the tower during hoisting of the blade.

33. A method as claimed in claim 1 wherein the hoisting occurs from a hoist point above the blade.

34. A method as claimed in claim 33 wherein the hoist point is fixed relative to the tower.

35. A method as claimed in claim 33 or 34 wherein the hoist point is located such that there is a gravitational bias on the blade and its secured carriage(s) during hoisting towards the tower surface of surfaces.

36. A method as claimed in any one of claims 1 to 35 wherein a winch to hoist the blade is supported by the ground on which the tower is supported.

37. A method as claimed in any one of claims 1 to 35 wherein a winch to hoist the blade is secured by the ground on which the tower is supported.

38. A method as claimed in any one of claims 1 to 35 wherein a winch to hoist the blade is secured to and on the ground on which the tower is supported.

39. A method as claimed in any one of claims 3 to 19 wherein the support cable or rope during hoisting extends from the blade or said at least one carriage upwardly to a hoist point.

40. A method as claimed in any one of claims 3 to 19 wherein the support cable or rope during hoisting extends from the blade or said at least one carriage upwardly to a hoist point and from the hoist point toward the ground to a hoist winch.

41. A method as claimed in any one of claims 1 to 40 wherein after securing the blade the at least one carriage is removed from the blade.

42. A method as claimed in any one of claims 1 to 41 wherein after securing the blade the at least one carriage is removed from the blade and lowered to the ground.

43. A method as claimed in any one of claims 1 to 42 wherein after securing the blade the at least one carriage is removed from the blade and lowered to the ground by the support cable.

44. A method as claimed in any one of claims 1 to 43 wherein the blade is delivered from a remote location to the wind power generator by a support vehicle preferably being a road vehicle (e.g. by a truck, e.g. on the trailer of the truck).

45. A method as claimed in any one of claims 7 to 44 wherein the blade is delivered from a remote location to the wind power generator by a support vehicle and the crane is mounted to said vehicle.

46. A method for removing a wind turbine blade from a rotor head of a nacelle located on top of a tower of a wind power generator, the method comprising:
a. un-securing root bolts of the blade with rotor head.
b. moving the blade to remove the root bolts from the bolt apertures, and
c. lowering the blade down the tower in an orientation presenting the blade root uppermost and the blade extending substantially vertically, guided by the tower by at least one carriage intermediate the blade and the tower and that is removably secured to the blade and that is in contact with an outer surface or surfaces of the tower as the blade is lowered.

47. A method as claimed in claim 46 wherein the at least one carriage is secured to the blade before said lowering.

48. A method as claimed in claim 46 or 47 wherein the at least one carriage is an upper carriage secured to the blade during lowering at or proximate the blade root.

49. A method as claimed in any one of claims 46 to 48 wherein said lowering is by a support cable or rope releasably attached to the blade and/or the at least one carriage (preferably the upper carriage).

50. A method as claimed in any one of claims 46 to 49 wherein the method further comprises, prior to said lowering (and preferably prior to said un-securing), attaching a support cable or rope to (preferably a hoist anchor of) the blade and/or at least one carriage.

51. A method as claimed in any one of claims 46 to 50 wherein the blade is lowered onto a support vehicle or support rack.

52. A method as claimed in claim 51 wherein the blade is transitioned from vertical tower guided hoisting condition to its horizontal condition to by a crane.

53. A method as claimed in claim 51 wherein the blade is transitioned from vertical tower guided hoisting condition to its horizontal condition to by a crane that can lift the blade.

54. A method as claimed in claim 51 wherein the blade is transitioned from vertical tower guided hoisting condition to its horizontal condition to by a crane that can lift the blade at a location spaced from the hoist anchor.

55. A method as claimed in claim 54 wherein the location spaced apart, is defined by a lifting anchor of the blade.

56. A method as claimed in claim 55 wherein the lifting anchor is located more proximate the blade tip than then where the lowering of the blade occurs.

57. A method as claimed in any one of claims 52 to 56 wherein, in the horizontal condition, the blade and the at least one carriage are separated from the tower.

58. A method as claimed in any one of claims 52 to 57 wherein the crane and the support cable in concert suspend and move the blade from its vertical lowering condition to its horizontal condition.

59. A method as claimed in claim 46 wherein the lowering occurs from a hoist point above the blade.

60. A method as claimed in any one of claims 46 to 59 wherein a winch to lower the blade is supported by the ground on which the tower is supported.

61. A method as claimed in any one of claims 46 to 60 wherein a winch is secured by the ground on which the tower is supported.

62. A method as claimed in any one of claims 46 to 61 wherein a winch is secured to and on the ground on which the tower is supported.

63. A system for installing and/or removing a wind turbine blade to or from a rotor head of a nacelle located on top of a tower of a wind power generator, the system comprising
a. support cable or rope able to support the blade in a vertical condition and hoist and/or lower said blade from a location above the blade,
b. at least one carriage to locate intermediate the blade and the tower and be removably secured to the blade and be in contact with an outer surface or surfaces of the tower as the blade is hoisted and/or lowered by the support cable, said at least one carriage comprising a mechanism that allows the relative position of the blade and the tower to be adjusted to position the blade root in alignment with a blade mounting flange of the rotor head so that root bolts are able to insert into the root bolt apertures, by adjusting the position of the blade relative to the tower using the at least one carriage.

64. A system for installing and/or removing a wind turbine blade to or from a rotor head of a nacelle located on top of a tower of a wind power generator, the system comprising
a. support cable or rope able to support the blade in a vertical condition and hoist and/or lower said blade from a location above the blade,
b. at least one carriage to locate intermediate the blade and the tower and be removably secured to the blade and be in contact with an outer surface or surfaces of the tower as the blade is hoisted and/or lowered by the support cable,
c. a crane able to lift the blade and in concert with the support cable to cause the blade to transition between its vertical condition parallel and adjacent the tower and a horizontal condition distal more the tower.
